(19) United States
(12) Patent Application Publication
(10) Pub. No.: US 2007/0133591 A1
(43) Pub. Date: Jun. 14, 2007

(54) Synchronizing token time base

(75) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: TRI-D Systems, Inc., Pasadena, CA (US)

(21) Appl. No.: 11/634,029

(22) Filed: Dec. 4, 2006

Related U.S. Application Data
(60) Provisional application No. 60/742,662, filed on Dec. 5, 2005.

(51) Int. Cl. H04L 12/42; H04L 12/56

(52) U.S. Cl. 370/457; 370/395.2

(57) ABSTRACT

In a method and system for initializing a time-based one-time-passcode authenticating token, a clock of the token is started at a known initial setting. The token generates an initial one-time-passcode using the time on the clock. Initialization information including the initial one-time-passcode is sent to a server. When the initialization information is received at the server, the server is configured to generate expected one-time-passcodes using the same clock time as the token.

### CROSS REFERENCE TO RELATED APPLICATIONS

This application claims benefit of U.S. Provisional Patent Application No. 60/742,662, filed Dec. 5, 2005, which is incorporated herein by reference in its entirety. This application is related to U.S. patent application Ser. No. 11/***,***, attorney docket no. 46428-0012-00-US, filed concurrently herewith for “Creating Multiple One-time Passcodes,” which is incorporated herein by reference in its entirety.

### BACKGROUND

The present invention relates to initializing clocks used in time-based authentication tokens and devices.

Authentication tokens are available that present a one-time-passcode (OTP), which the user uses to authenticate himself or herself to a resource or facility, for example, a server or application. For conciseness, the server, application, or other resource or facility is referred to below generally as a “server.” In general, the term “server” is to be understood as denoting any device or system capable of receiving and validating an OTP from an authentication token. The server typically maintains a list of authorized users, usually human individuals, and the token each user has been assigned. The server or application also has a method by which it stays synchronized with each token, so the server can determine what OTP it expects from the token on each occasion when an alleged OTP is presented.

Typical one-time authentication tokens use a strong encryption method for generating the OTP. Typically each token uses a unique “random” encryption key. When a token is issued to a user the server is given information about the user and the token issued to the user. This information typically includes the user's login name and password, the encryption key of the token, and the initial value of a variable used to generate the sequence of OTPs.

One-time authentication tokens may be either event-based or time-based. Event-based tokens use a counter as the basis for generating a sequence of OTPs. This counter is incremented in a known method and with each use the token and the server increment synchronized counters with similar methods. If the OTP presented by the user is the same as the OTP generated by the server for that user, then the user is granted access to the server or other controlled resource. An event-based one-time authentication token may be initialized by presetting the token and the server to the same known point in the token's sequence. By storing the state of the counter, the token and the server then remain synchronized until the token is brought into use. Some event-based one-time authentication token servers will accept any of the next few passcodes along the sequence, allowing the server to resynchronize with the token if for any reason one or a few passcodes have been skipped.

Time-based tokens rely on a clock as the basis for generating the one-time-passcode. Self-contained time-based tokens include the clock in the token itself This clock is typically a real-time-clock (RTC) and the generated one-time-passcode is based on a known method using this RTC. The server maintains a list for each token, including an initial time-base for each token and uses a similar method for generating OTPs. The server uses a standard source for its own RTC, and if the OTP presented by the user's token is the same as the OTP generated by the server for that user at that time of day, then the user is granted access to the server or other resource controlled by the server.

The clock in time-based tokens is started either when the token is manufactured or when the encryption key is loaded, and this is the initial clock value. The initial value is typically set to a standard time base, such as GMT. Using GMT, or some other standard time base, for the server and all associated tokens makes it easier to issue tokens because the only information needed by the server is the encryption key.

Starting the clock before it is really required, and with a standard time base, can cause problems. The clock used in a self-contained token does not keep perfect time and can drift in an unpredictable manner. This requires the server to initially resynchronize with the token, potentially over a large drift from the initial clock value in the token. If the drift is too large the server will not be able to re-synchronize. As a security problem, in some systems when a token is brought into active use the server must recognize the token from the first OTP received, in order to associate the token with a user. A failure to resynchronize could then cause the wrong token to be “recognized,” which would invalidate both the correct token and the wrong token. Using a standard time base for every token reduces the security because the encryption key may be more easily determined knowing the time from which the OTP is generated. Further, running an RTC before it is needed, when the token has not yet been issued to a user but is merely sitting on the shelf, takes power and reduces the life of the token. Power consumption is an important issue with credit-card sized tokens, where the volume available for batteries, and therefore the total energy storage capacity, is seriously limited.

There is therefore a continuing need for methods and systems that can provide reliable synchronization of a time-based token with a server or application when the token is brought into active use. There is also a continuing need for a time-based token that does not draw unnecessary energy from the token's battery before the token is brought into active use.

### SUMMARY

Embodiments of the present invention are directed to time-based authentication tokens, and to methods and apparatus for initializing and recognizing time-based authentication tokens.

In one embodiment of the invention, there are provided a method of and system for initializing a time-based one-time-passcode authenticating token, in which a real-time clock of the token is started at a known initial setting, an initial one-time-passcode is generated using the time on the real-time clock, and initialization information including the initial one-time-passcode is sent to a server.

In another embodiment of the invention, there are provided methods and systems for initializing recognition of a time-based authenticating token, in which a purported initial one-time-passcode is received, an expected initial one-time-passcode for a time-based token is determined using a known initial setting of a clock of the token, and where the received purported passcode matches the expected passcode, the server is configured to determine the clock time of the token at later times using the known initial setting and the time at the server at which the received initial one-time-passcode is received, and the server is configured to determine expected passcodes from the token for later times using the determined clock time.

The method and system may then receive a subsequent purported passcode from the token, determine an expected passcode for the token for the time at which the purported passcode is received, and determine whether or not the received passcode matches the expected passcode.

In a further embodiment of the invention, there is provided a one-time-passcode authenticating token comprising a clock, a unique key, and a processor arranged to generate a one-time-passcode using the unique key and a time from the clock, wherein the token can be switched from an inactive mode in which the unique key remains stored on the token and the clock does not run to an active mode in which the unique key remains stored on the token and the clock runs, and wherein the token is programmed to set the clock to a known initial setting when switched from the inactive mode to the active mode.

The system may be embodied at least in part using one or more computers, and another embodiment of the invention provides programs for causing a computer to carry out the methods of the invention.

In a further embodiment of the invention, there is provided a software program which, when running on a computing system is arranged to cause the computing system to receive a purported initial passcode from a token, determine whether that passcode is the expected passcode for a known initial setting of a clock of the token, record the setting of the clock of the token using a time at which the initial passcode is received, receive a subsequent purported passcode from the token, determine an expected passcode for the token for the time at which the purported passcode is received, and determine whether or not the received passcode matches the expected passcode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic diagram of an embodiment of a token according to the present invention.

FIG. 2 is a schematic diagram of an embodiment of a computer system according to the present invention.

FIG. 3 is a flowchart of an embodiment of the present invention.

### DETAILED DESCRIPTION

Reference will now be made in detail to various embodiments of the present invention, examples of which are illustrated in the accompanying drawings.

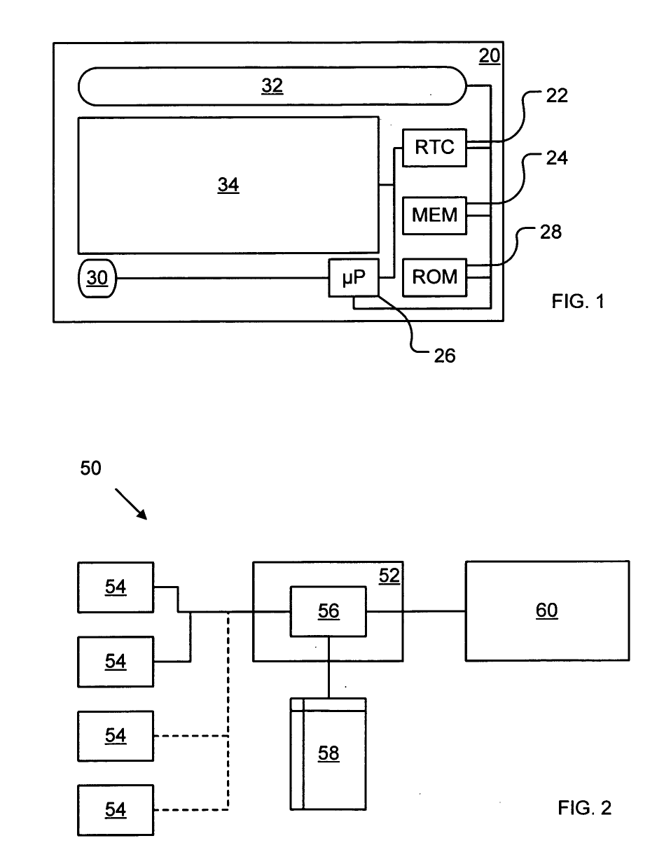

Referring to the drawings, and initially to FIG. 1, one form of token constructed in accordance with an embodiment of the present invention, indicated generally by the reference numeral 20, comprises a device substantially the size and shape of a credit card, that is to say, approximately 85 mm by 54 mm by 0.8 mm thick. The token 20 comprises a real-time clock (RTC) 22, a memory 24, which may be a non-volatile memory, for storing a unique key, a processor 26, a program ROM 28 containing a program for the processor, an actuation button 30 on the exterior of the token, a display 32 on the exterior of the token, and a battery 34.

When the token 20 is active, operating the button 30 causes the processor 26 to run the program from the ROM 28, generate a one-time-passcode (OTP) using the time from the RTC 22 and the unique key from the memory 24, and display the OTP on the display 32.

The unique key in the memory 24 may be, for example, an encryption key or a hashing key. A hashing key that returns a hash value of constant length irrespective of the time value received from the RTC 22 is presently preferred. However, other forms of key currently available or hereafter to be developed may be used, typically incorporating or in combination with some form of encryption, provided that the function of generating an OTP is effectuated. Typically, the OTP should be generated using the key in the memory 24 and the time according to the RTC 22 in such a way that current or future OTPs from a given token 20 cannot easily be predicted even with detailed knowledge of other similar tokens 20 and with knowledge of recent earlier OTPs from the given token 20. The token 20 may use any suitable method of generating an OTP that meets those objectives to a desired standard.

The OTP is displayed for a short period, which may be programmed or may be, for example, only as long as the button 30 is held. The token 20 then returns to a standby mode in which the RTC 22 continues to run, and the memory 24 is maintained, but all other functions are shut down to save power.

The token 20 may return immediately from the active mode to the standby mode, or may pass through an intermediate mode in which, for example, the display 32 is shut down but the OTP is held in memory and/or the processor 26 remains active, so that the OTP can be recalled to the display or a new OTP can be generated quickly. The memory 24 may be a non-volatile memory that requires no power to maintain it, or may be a memory requiring a very low power supply. The processor 26 may stand by at a very low level of activity to monitor for actuation of the button 30, or the processor may be entirely shut down until actuation of the button 30 closes a contact to supply power to the processor. The main load on the battery 34 in the standby mode is the RTC 22.

The token 20 has an even lower level inactive mode, in which the RTC 22 and the processor 26 are not running. Depending on the type of memory 24, the battery may then be supplying only the maintenance power for the memory, or may be supplying no load at all. In the inactive mode, the token 20 can be stored for months or even years without a substantial drain on the battery 34, depending largely on the intrinsic properties of the battery 34.

The key may be loaded into the memory 24 when the token 20 is manufactured, or at some later time. If the key is loaded after manufacture, then the token 20 is arranged to be activated to enable the key to be loaded, and then returned to the inactive mode. Where the inactive mode supplies a maintenance current to the memory 24, even that inactive mode is not initiated until the key is loaded.

Referring to FIG. 2, a computer system indicated generally by the reference numeral 50 comprises an authentication server 52 and various user terminals or other access points 54. The user terminals 54 may be, for example, computers connected to the server 52 over the internet or other wired or wireless networks. The server 52 comprises a processor 56, which maintains a database 58 of the authentication tokens 20 authorized for use on that network. For each token 20, the database 58 may contain the usename and password of the authorized user, the key in the memory 24 (or, in the case of a one-way cipher, the decryption key corresponding to the encryption key in the memory 24), and the offset between the RTC 22 and the server's standard clock. If the program that generates the OTP from the key and the time from the RTC 22 is not standard for all tokens 20 in the system, then the program for each token is also included in the database 58.

The authentication server 52 grants or denies users at terminals 54 access to other computing resources 60.

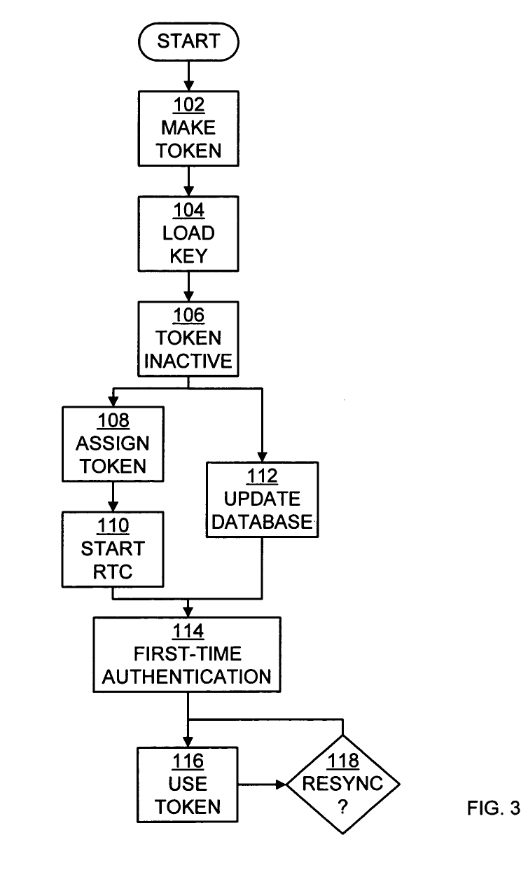

Referring now to FIG. 3, in an embodiment of a process according to the invention, in step 102 a token 20 is manufactured. The battery 34 is installed, but the real-time-clock (RTC) 22 in the token 20 is turned off and the token is kept in a very low power state, or can be completely turned off. In step 104, the key is loaded into the memory 24. The key may be added to the token during manufacture, or at any later time. During the key loading process the token 20 may be fully powered, and the RTC 22 may be activated, depending on the design of the token. Once the key has been loaded into the memory 24, in step 106 the RTC 22 is turned off and the token returned to a very low power inactive state. If the memory 24 containing the key is permanent or semi-permanent memory not requiring a maintenance current, then the token 20 can be completely turned off.

Most self-contained tokens use very small batteries 34. Where the token 20 has a credit-card format, the volume of the battery is limited by the volume of the credit card. The very low power inactive state provided by the present system has a very small effect on the life of the battery 34. The token 20 can have a very long shelf life, up to many months or even years, with little or no effect on the subsequent usable life of the token. This is especially true when the token 20 is completely turned off and the shelf life is based on the characteristics of the battery 34.

In step 108, the token 20 is assigned to a user, and the user, or the person issuing the token 20, activates the token. Part of the activation process is to turn on the RTC 22 in the token 20 in step 110. The token 20 is configured so that the RTC 22 will set to a known initial value when the RTC is turned on. For example, the RTC may set itself to zero or another fixed, arbitrary, value. For greater security, the RTC 22 may be set by the processor 26 to a value determined by the serial number of the token 20, by the key, or by some other known property of the individual token 20.

If the token 20 was in a very low power inactive state, the token 20 is returned to its normal full power mode. If the token 20 was completely turned off, the token is turned on to the full power mode. With many tokens, the fully operational state may consist of a few different power modes. For example, some tokens only show the OTP on the display 32 for a brief while and then turn off the display. The power mode with the display on is different from the power mode with the display turned off, and the standby mode may be different again, but these operating modes all require more power than the inactive state with the RTC 22 turned off.

In step 112, the database 58 of the server 52 is updated with information about the user and the token 20 issued to the user. This information may include the user's login name, the user's password, the serial number of the user's token 20, the key contained in the memory 24 of the token, information about the OTP generation method, information about how the RTC 22 in the token is turned on, information about how the RTC in the token is initialized, information about the requirements for the first-time authentication, and other information. The server also maintains some information about the activation state of the token 20. In the interests of clarity, step 112 is shown in FIG. 3 as occurring side-by-side with steps 108 and 110. Parts of the updating of database 58 typically occur at about the same time as the token 20 is issued to the user. For example, the user identification cannot be updated until it is known what token 20 is being assigned to what user. However, other information may be updated at other times. For example, at least some information about the token 20 may be entered into the database 58 as soon as the token 20 is assigned to the system 50, which may be much earlier than the token 20 is assigned to a user. The user's password may be updated from time to time while the token is in use: many systems require passwords to be changed at regular, frequent intervals.

In step 114, the user performs a “first-time” authentication process with the authentication server 52. The first-time authentication process confirms the identity of the user, confirms that the user is using the token issued to that user, and confirms that the token is operating properly. Confirming the identity of the user may only require entry of the user's login name and password, but in some cases more information about the user may be required.

The first-time authentication process may also require that the user supply an OTP and that this initial OTP match the OTP generated on the server for the user's issued token assuming given start-up conditions for the token. Provided a property unique to the individual token 20 was chosen to initialize the RTC 22, the initial OTP is also expected to be unique, excluding the risk of the wrong token 20 being identified and authenticated, even if the serial number of the token 20 is not separately verified. The first-time authentication process may require more than one OTP. This can almost eliminate the possibility of guessing, either by simple guess or brute force attack, the initial OTP.

Because the OTP is derived from the time on the RTC, the two or more OTPs required must be generated at times spaced apart by more than the clock cycle of the RTC. Authenticating tokens are often arranged to display each OTP for one minute, and consequently are arranged to update the OTP once per minute. The user must therefore wait for one minute between entering successive OTPs. However, because that is required only for the first-time authentication process, the wait between OTPs is unlikely to be a major inconvenience. Alternatively, the RTC 22 can be placed under control of the processor 26 during the first-time authentication process, to ensure a completely predictable sequence of OTPs. Alternatively, multiple OTPs may be generated within a single minute using the principles of application Ser. No. 11/***,*** for “Creating Multiple One-time Passcodes.”

Because this first-time authentication process is synchronized with the turning on of the RTC 22 in the token 20, the initial state of the RTC is well defined and no compensation for drift needs to be included in the first-time authentication process. This eliminates the possibility of not being able to use the initial OTP because the RTC 22 has drifted too much, and eliminates the possibility that an incorrect token is being used. The authentication server 52 then records in the database entry 58 for the individual token 20 the time when the RTC 22 was started, either as an absolute time, as an offset from the server's master clock, or in some other convenient form.

As noted above, the initial state for the RTC 22 can be easily controlled by the token 20 and established as a basis for the first-time authentication between the token 20 and the server 52. Especially if the constant starting value of the RTC 22 is not generally known to outsiders, combining this with a “random” key and a strong OTP generation algorithm can provide a very strong initial OTP. Setting the RTC 22 to an initial value based on the key loaded into the token 20 can provide an even stronger initial OTP. Setting the RTC 22 to an initial value based on a first-time OTP generation process can provide an even stronger, almost un-guessable, initial OTP. Any of these initial RTC values helps to provide a difficult to guess initial OTP.

Since the time of the first-time authentication by the user is also fairly random, the subsequent OTPs become even stronger, at least where a would-be intruder does not know when a specific token 20 was authenticated.

In step 116, the user continues to use the token 20. To access the computing resources 60, the user at a terminal 54 logs in through the authentication server 52, using the user's login name and password, and the OTP from the token 20. Provided these all match, the user is granted access to the resources 60, to the extent proper to the identified user.

In step 118, the server 52 checks for the accuracy of the RTC 22 in the token 20. The server 52 may be programmed to accept an OTP that is correct for a time slightly before or slightly after the time shown by the server's master clock (after correcting for the starting time of the RTC 22), and to adjust the recorded starting time of the RTC to resynchronize the RTC with the master clock. If the type of RTC 22 used is prone to drift at a steady rate that varies from one individual clock to another, the server 52 may be programmed to determine and expect the drift rate.

Therefore, the present device makes it possible to solve, or substantially mitigate, problems of time-based authentication tokens. Energy consumption in storage can be reduced because the RTC 22 is not turned on until it is needed. Inability to authenticate with the token 20 because of too much clock-drift can be eliminated by using a known initial setting of the RTC. The risk of authentication to an incorrect token while trying to account for clock drift can be eliminated because each token has a predictable, and preferably unique, initial OTP. A random activation event can provide a strong initial RTC value making it more difficult to determine the key.

While the foregoing specification has been described with regard to certain preferred embodiments, and many details have been set forth for the purpose of illustration, it will be apparent to those skilled in the art without departing from the spirit and scope of the invention, that the invention may be subject to various modifications and additional embodiments, and that certain of the details described herein can be varied considerably without departing from the basic principles of the invention.

For example, the token 20 has been described as cooperating with an authentication server 52 that allows or denies access to computing resources 60. The authentication may instead be managed directly by an application that the user desires to access. The one-time passcode may alternatively be used to access any resource that is controlled by a passcode, for example, as an access code on a door to a physical facility. The passcode has been described as being read off a display 32, but may alternatively be transmitted directly to the authentication server 52 or other recipient if the token 20 is, for example, a smartcard with electronic data contacts, or a PC card or other device that can be plugged into a computer or other electronic device.

The user has been described as entering a user login name and password as well as the OTP. Alternatively, or in addition, other methods, known or hereafter to be developed, of identifying the user may be used. For example, biometric data may be used. The token 20 itself may be a biometric card as described in my U.S. patent application Ser. No. 2004/0030660.

Where an OTP or other datum is described as unique, universal uniqueness is not required. Local uniqueness within the system 50 is generally sufficient, and statistical local uniqueness, in the sense that a duplicate is highly unlikely to occur, is typically adequate provided that the statistical likelihood of a duplication is set sufficiently low for the requirements of a given system.

In the interests of linguistic simplicity, the delays arising between the moment when the user presses the button 30 and the moment when the server 52 authenticates the OTP have been ignored. However, in a real system, especially one that involves a human user reading and keying in the passcode, a delay of several seconds may occur. If the clocks tick over a minute during that delay, the token 20 and the server 52 may be one passcode out of step. If the clock cycle is shorter than a minute, and/or if other delays arise, a discrepancy of more than one step in the sequence of passcodes may occur, even without allowing a tolerance for clock drift. The server 52 may therefore be programmed to generate a range of successive passcodes for times equal to or offset from the exact time indicated by the master clock, and to accept any of those passcodes from the token user, with or without other constraints. References to the time or the passcode matching are to be understood accordingly as including, in appropriate cases, a match with an acceptable offset.

In addition, when the RTC 22 is started, there may be a significant delay before the user requests the initial OTP from the token 20. Consequently, the “initial” OTP actually sent by the user to the server 52 may correspond to a time after the starting time of the RTC 22. The server 52 may therefore be programmed to generate all the OTPs for a period of time beginning with the initial value of the RTC 22, and to accept any of those OTPs as a valid initial OTP. The server 52 then preferably identifies which OTP in the initial sequence was received, and calculates back to determine the exact time at which the RTC 22 was actually started. Depending on the use and circumstances of the particular system 50, the period of time after starting the RTC 22 within which an acceptable OTP can be generated may typically be from 15 minutes to 24 hours, but longer or shorter periods may be used.

Thus, it is intended that the present invention cover the modifications and variations of this invention provided they come within the scope of the appended claims and their equivalents.

What is claimed is:

1. A method of initializing a time-based one-time-passcode authenticating token, comprising:
starting a real-time clock of the token at a known initial setting;
generating an initial one-time-passcode using the time on the real-time clock; and
sending initialization information including the initial one-time-passcode to a server.

2. A method according to claim 1, wherein the known initial setting is selected from the group consisting of a fixed initial setting and a setting generated using at least one of a serial number of the token and a key stored on the token.

3. A method according to claim 1, further comprising subsequently causing or permitting the real-time clock to run continuously, and using the token to generate one-time-passcodes each using the time on the real-time clock when the passcode is generated.

4. A method according to claim 1, wherein the initialization information further comprises information selected from a user login name of a user to whom the token is being issued, a user password of the user, and a serial number of the token.

5. A method according to claim 1, further comprising providing the token in an inactive state wherein a unique key is stored on the token and the real-time clock is not running, before said step of starting the real-time clock.

6. A method according to claim 5, further comprising activating the token, storing a unique key on the token, inactivating the token, and storing the token in the inactive state.

7. A method according to claim 1, further comprising receiving the initialization information at the server, and configuring the server to generate expected one-time-passcodes using the same clock time as the token.

8. A method according to claim 7, wherein configuring the server further comprises determining the clock time at the server using the known initial setting of the real-time clock of the token and the time at which the initialization information is received at the server.

9. A method according to claim 8, wherein determining the clock time further comprises storing an offset between the determined clock time and a standard time of the server.

10. A method according to claim 7, further comprising granting or denying access to resources depending on whether received passcodes match expected passcodes.

11. A method of initializing recognition of a time-based authenticating token, comprising:
receiving a purported initial one-time-passcode;
determining an expected initial one-time-passcode for a time-based token using a known initial setting of a clock of the token; and
where the received purported passcode matches the expected passcode, configuring the server to determine the clock time of the token at later times using the known initial setting and the time at the server at which the received initial one-time-passcode is received, and configuring the server to determine expected passcodes from the token for later times using the determined clock time.

12. A method according to claim 11, wherein configuring the server comprises storing an offset between the clock time of the token and a standard clock of the server.

13. A method according to claim 11, further comprising receiving a purported serial number of a token, and determining the expected passcode for the token identified by the purported serial number.

14. A method according to claim 11, further comprising determining the expected initial passcodes for a plurality of available tokens, and where the received purported passcode matches any one of the expected initial passcodes recognizing the token corresponding to the matched expected initial passcode.

15. A method according to claim 11, further comprising receiving information identifying a user of the token, and configuring the server to accept at a later time only a combination of specified information identifying the user and a passcode matching the expected passcode for the later time.

16. A one-time-passcode authenticating token comprising:
a clock;
a unique key, and
a processor arranged to generate a one-time-passcode using the unique key and a time from the clock;
wherein the token can be switched from an inactive mode in which the unique key remains stored on the token and the clock does not run to an active mode in which the unique key remains stored on the token and the clock runs; and
wherein the token is programmed to set the clock to a known initial setting when switched from the inactive mode to the active mode.

17. A token according to claim 16, wherein the initial setting is a fixed setting or a setting determined using at least one of a serial number of the token and the unique key.

18. A token according to claim 16, wherein the unique key is an encryption key or a hashing key.

19. A token according to claim 16, in combination with a server arranged to receive a one-time passcode from the token, to determine an expected passcode for that token at that time, and to determine whether the received passcode matches the expected passcode,
wherein the server is arranged to receive an initial passcode from the token, to determine whether that passcode is the expected passcode for the known initial setting of the clock of the token, and to record the setting of the clock of the token using the time at which the initial passcode is received.

20. A combination according to claim 19, wherein the server is arranged to record an offset between the clock of the token and a master clock of the server.

21. A system for authenticating passcodes, arranged in operation to:
receive a purported initial passcode from a token;
determine whether that passcode is an expected passcode for a time within a period starting at a known initial setting of a clock of the token; and
where the purported initial passcode matches an expected initial passcode, activate the token and record the setting of the clock of the token using a time at which the initial passcode is received.

22. A system according to claim 21, arranged in operation to:
receive one or more subsequent purported passcodes from the token;
determine one or more respective expected subsequent passcodes for the token for the times at which the one or more subsequent purported passcodes are received;
determine whether or not the one or more received subsequent passcodes match the respective expected subsequent passcodes; and
validate the token only if the one or more received subsequent passcodes match the respective expected subsequent passcodes.

23. A system according to claim 21, arranged in operation to
receive a subsequent purported passcode from a token that has been validated;
determine an expected passcode for the token for the time at which the purported passcode is received;
determine whether or not the received passcode matches the expected passcode; and
recognize the token only if the received passcode matches the expected passcode.

24. A system according to claim 21, comprising a computing device comprising a program arranged when running to cause the computing device to carry out the said recording, receiving, and determining.

25. A software program which, when running on a computing system is arranged to cause the computing system to:
receive a purported initial passcode from a token;
determine whether that passcode is an expected passcode for a time within a period starting at a known initial setting of a clock of the token; and
where the purported initial passcode matches an expected initial passcode, activate the token and record the setting of the clock of the token using a time at which the initial passcode is received.

26. A software program according to claim 25, further arranged to cause the computing system to grant or deny accesses to one or more resources in dependence at least in part on the determination whether or not a received passcode matches an expected passcode.

27. A software program according to claim 25, embodied in a machine-readable medium.
